(19) United States
(12) Patent Application Publication
(10) Pub. No.: US 2026/0227890 A1
(43) Pub. Date: Aug. 6, 2026

(54) AI-POWERED DIAGRAMMING TOOL

(71) Applicant: Zapier, Inc., San Francisco, CA (US)

(72) Inventors: Ben Biran, San Francisco, CA (US); Jacob Alexander Moghtader, San Francisco, CA (US); Luke Thomas, San Francisco, CA (US); Michael Sholty, San Francisco, CA (US); Seth Etter, San Francisco, CA (US)

(21) Appl. No.: 19/463,861

(22) Filed: Jan. 29, 2026

Related U.S. Application Data
(60) Provisional application No. 63/754,971, filed on Feb. 6, 2025.

(51) Int. Cl. G06F 3/0484; G06F 9/451; G06T 11/26; G06T 11/60

(52) U.S. Cl. CPC G06F 3/0484; G06F 9/451; G06T 11/26; G06T 11/60; G06T 2200/24

(57) ABSTRACT

The present disclosure provides an AI-powered diagramming tool that helps users visualize, plan, and automate workflow processes. In some embodiments, this tool provides a diagramming interface with drag-and-drop functionality that maintains real-time synchronization with an underlying automation platform, such that changes made to visual diagrams are immediately reflected in corresponding automation configurations, and vice versa. Users can create automation workflows by describing desired goals in natural language, and the AI-powered tool automatically generates functional automation assets (e.g., tables, interfaces) for data processing. The present system improves computing resource coordination through structured, machine-interpretable workflow diagrams, enabling efficient orchestration of distributed components, reducing redundant processing, and minimizing unnecessary execution paths. The diagraming tool also supports real-time collaboration with live cursors, commenting features, and sharing capabilities.

### CROSS REFERENCE TO RELATED APPLICATION

This application claims the benefit of U.S. Provisional Patent Application No. 63/754,971, titled “AI-Powered Diagramming Tool,” and filed on Feb. 6, 2025, the entire content of which is incorporated by reference herein.

### TECHNICAL FIELD

This disclosure relates to an AI-powered diagramming tool for streamlining automation workflows by visualizing, mapping out, and optimizing automated processes.

### BACKGROUND

Automation enables various applications and services to communicate seamlessly, reducing repetitive, time-consuming tasks. Using automation to understand and organize workflows and streamline operations to ensure data flows smoothly across disparate applications and services is becoming overwhelming. The automation process itself, however, can grow increasingly complex due to the numerous applications, conditional logic, and iterative steps. There is a need for a clear and collaborative space for users to plan, design, and optimize automation workflows.

### SUMMARY

To address the aforementioned shortcomings, a method and a system for generating and implementing automation workflows are disclosed herein. The method receives, via at least one user interface, user input describing an automation workflow. The method analyzes, using one or more artificial intelligence (AI) models, the user input to identify a plurality of automation requirements, wherein the automation requirements include at least one of applications to be integrated, data to be processed, actions to be performed, and conditional logic. The method also generates, based on the automation requirements, a visual workflow diagram comprising a plurality of automation elements. The method further implements the automation workflow by configuring and executing the plurality of automation elements within the visual workflow diagram.

The automation elements comprise one or more of automation steps, split paths, grouped nodes, interfaces, tables, and connectors. In some embodiments, a user request for modifying an automation element or making a potential optimization is received, via the at least one user interface, at any time in generating and configuring the visual workflow diagram, where the automation element is a new automation element or one of the plurality of automation elements. In some embodiments, in response to receiving the user request, existing automation elements within the visual workflow diagram can be analyzed using the one or more AI models, and one or more contextual recommendations are generated based on analyzing the existing automation elements. In some embodiments, the one or more contextual recommendations with user interface controls are displayed in the at least one user interface. An acceptance or a rejection of each of the one or more contextual recommendations can be received from a user via the user interface controls. In response to receiving an acceptance of a contextual recommendation, the visual workflow diagram is automatically modified to implement the accepted recommendation, and one or more options are provided for the user to subsequently edit the accepted recommendation.

The user input or user request is a natural language description in a form of text or voice input. In some embodiments, real-time bidirectional synchronization is maintained between the visual workflow diagram displayed in the at least one user interface and corresponding automation configurations. In some embodiments, access to the visual workflow diagram is shared with a plurality of users. In some embodiments, concurrent edits of the workflow diagram are received from the plurality of users. The concurrent edits are merged to maintain a consistent state of the visual workflow diagram. One or more conflict resolution algorithms are applied when a conflict arises from the concurrent edits to a same automation element in the visual workflow diagram.

In some embodiments, a user is enabled to add a free-form or element-specific comment. In some embodiments, a selection of a subset of the plurality of automation elements in the visual workflow diagram is received from a user. A grouped node of the selected subset of automation elements is created, where the automation elements are moved together when the grouped node is moved, and the automation elements are unaffected when the grouped node is deleted. In some embodiments, a selection of a subset of the plurality of automation elements in the visual workflow diagram and a selection of a layout organization option are received from a user, and a layout of the selected subset of automation elements is automatically organized according to the selected layout organization option. In some embodiments, implementation of the automation workflow is monitored to collect performance statistics.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIGS. 1A and 1B illustrate exemplary user interfaces for initiating an AI-powered diagramming tool, according to some embodiments.

FIGS. 2A-2C illustrate a high-level diagram for an exemplary automation process using the AI-powered diagramming tool, according to some embodiments.

FIGS. 3A-3D illustrate example diagramming operations, according to some embodiments.

FIGS. 4A-4G illustrate a specific diagram for an exemplary automation process using the AI-powered diagramming tool, according to some embodiments.

FIG. 5 illustrates an exemplary flow diagram of a method for generating and implementing automation workflows, according to some embodiments.

FIG. 6 illustrates a block diagram of an example computer system that may be used in implementing the technology described herein, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

The present disclosure provides a free artificial intelligence (AI)-powered diagramming tool that helps users visualize, plan, and automate workflow processes. The present system may use this tool to create a bird's eye view for the users regarding how their automations, applications, data, and other users tie into a specific process.

An automation or automated workflow allows a user to select two or more applications and connect the selected applications to customize and automate repetitive tasks. For example, an automation may include automatically generating and sending out a custom tweet after a user publishes a post in response to receiving a one-time input from the user. Automations may connect thousands of applications with different types of customized actions. For example, an automation may allow a user to share new posts on Linkedin®, add events of Instagram® and Reddit® to Google Calendar®, receive alerts in Slack® when receiving emails with attachments downloaded to Dropbox®, etc. The automations enable automatic and real-time synchronization of data updates, migration, and transfers between applications, services, and platforms.

The AI-powered diagramming tool described herein allows a user to tweak, adjust, and automate workflows at the click of a button. For example, a user wants to automate the way to capture leads. When someone submits information on the user's website, the present diagramming tool can send the information directly to a table for review. If the lead is hot, a notification can be sent out in an application (e.g., Slack). If the lead is a lower-priority lead, the present diagramming tool can automatically add the lead to an email sequence.

The present AI-powered diagramming tool is designed to help users visually map out and plan their automated workflows. This tool provides a flexible, drag-and-drop interface for organizing and structuring automation ideas (e.g., before building the automation). The present visual approach makes it easier to conceptualize complex workflows, identify potential optimizations, and share automation plans with other users.

Advantageously, the present diagramming tool may be applied to visualize complex workflows. It allows users to create flowcharts or diagrams to represent their automation ideas. Each step in a workflow may be represented as a node in a diagram, connected to other steps to show the data flow and process logic. This tool is especially useful when dealing with multi-step workflows involving several applications, conditional logic (e.g., if this happens, then do that), and loops or iterative processes. In addition, the present system provides the workflow in a visual format, which is easier to communicate and understand than a written or verbal explanation, and thus is especially useful for non-technical users.

Instead of jumping directly into building an automation, the present tool may allow users to outline a workflow step by step, identify any gaps or inefficiencies, and refine the automation process before implementation. In particular, this AI-powered diagramming tool can provide suggestions, guidance, and even corrections for properly and efficiently building the automation. This can reduce the likelihood of errors and save time during the actual creation of an automated workflow.

Using the present AI-powered diagramming tool, users or teams may collaborate on creating automation workflows, thereby contributing to the planning and aligning on automation strategies in organizations. For example, the present tool allows users to brainstorm and align automation goals, share visual workflows with different users and entities, and gain input and feedback before implementation.

The present AI-powered diagramming tool enables a complex workflow to be broken into smaller, more manageable steps, thereby simplifying the automation planning process. Based on these manageable steps, the present system may identify inefficiencies or redundancies in a workflow, enabling users to optimize processes for better performance and standardize the workflow for future use.

If a user is not ready to start building an automation but wants to plan his/her automation ideas, the present system allows such planning without disruption. The present system may provide a space/tool to draft a workflow without affecting existing automated workflows or setups, and test the draft workflow with different automation approaches. Once the workflow is planned, the automation is made “ready” for the user because the visual design in the draft space can be easily turned into a functioning automation by linking steps to specific applications and triggers in an automation platform. In other words, the present AI-powered diagramming tool is integrated with the automation platform to seamlessly transit an automation workflow from planning to execution based on the user's design. The present system allows users to start the workflow drafting and visualization with pre-built templates or design workflows from scratch depending on their needs, and the automation that is turned into action matches the user's original vision in the drafting tool or space.

The present system advantageously provides an AI-powered diagramming tool to simplify the process of planning and designing automation workflows by providing a visual interface to map out automation ideas (e.g., before implementation). The present system offers a clear and collaborative space to brainstorm, refine, and optimize automation workflows. The present system also eliminates trial-and-error during setup and ensures automation processes are efficient and well-structured. By enabling users/teams to collaborate, share, and visualize automation workflows, the present system not only streamlines the transition from idea to execution but also enhances communication and scalability, making it an invaluable resource for automating and optimizing operations in computer and network environments.

### System Features

As discussed above, the present system may employ an AI-powered diagramming tool to outline an overview picture of an automation workflow, capturing every step and every application along the way (e.g., from the first touchpoint to the last). In some embodiments, the present tool may be used to plan new automation workflows/processes, optimize existing workflows, and share the workflows with other users (e.g., teammates). To collaborate with other users, in some embodiments, the present system may allow users to add comments, tag specific users, and fine-tune each automation process together. Particularly, in some embodiments, the present system may transform an automation plan drafted using the present diagramming tool into an automated solution/action in the same spot and in real time. The present system can also provide users with AI-powered recommendations, for example, on what to do/create in the next step or build draft automation workflows for the users.

The present system offers a range of features designed to streamline and enhance workflow automation planning. Specifically, the present system may allow users to use AI (e.g., Microsoft Copilot®) to create workflows effortlessly by simply describing their desired goal (e.g., what the users would like to create). The feature of automated steps may enable the AI-powered diagramming tool described herein to easily integrate with an automation platform. That is, the present tool may create new workflows or pull existing automation workflows from the automation platform, and add these workflows to the diagramming or draft space provided by the present tool through automated steps. These automation flows include thousands of applications with options for tables, chatbots, and interfaces. The present system may also support default steps for actions requiring human input. These default steps are applied to handle the actions with split paths to account for different scenarios based on prior outcomes (e.g., the results of a previous step).

The present system may provide on-canvas field mapping functionality that allows users to map inputs and outputs directly within a diagramming interface without having to navigate to separate editing interfaces. This feature streamlines the workflow configuration process by enabling users to configure data flow between steps while maintaining visibility of the overall automation diagram. The present system may also provide support for agents, allowing users to add and configure AI-powered autonomous assistants without leaving the diagramming interface. Agents can perform tasks autonomously, make decisions, and execute actions within automation workflows, enabling more sophisticated and intelligent automation processes.

The present system may include an asset builder that allows users to type text into a step and convert that text into functional automation assets (e.g., interfaces, chatbots, or tables) using AI. This feature accelerates the process of creating automation components by eliminating the need for manual configuration. The present system may provide AI-powered step suggestions by reviewing existing steps within an automation process to recommend new steps that could improve or extend the process. A user may accept or reject a system-generated step suggestion. The present system may also provide keyboard shortcuts to enhance user efficiency, including shortcuts for cleaning up the entire layout to automatically straighten connectors and order steps. The present system may further allow users to apply automatic layout organization to selected subsets of steps, with options to organize the steps horizontally (e.g., left to right) or vertically (e.g., top to bottom).

Additionally or alternatively, the present system may use grouped nodes to organize steps and automation workflows into categories to simplify complex workflows. The feature of AI-powered recommendations may allow the present system to review the existing steps and provide additional automation suggestions to improve efficiency. The present system may provide time-saving estimates to track and visualize the time saved with the automation process using the AI-powered diagramming tool, clearly indicating the efficiency gains. The present system may also provide key metadata associated with automations, tables, and interfaces to monitor activity (e.g., runs, submissions, records) across the entire system. With rich text features, the present system may further enhance users'diagrams with images, links, checklists, and custom colors, ensuring an explicit and professional presentation of their workflows.

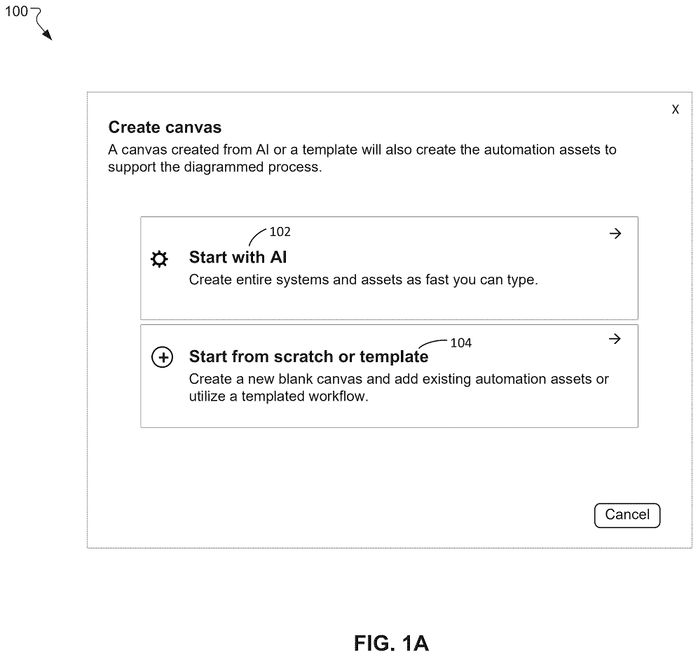

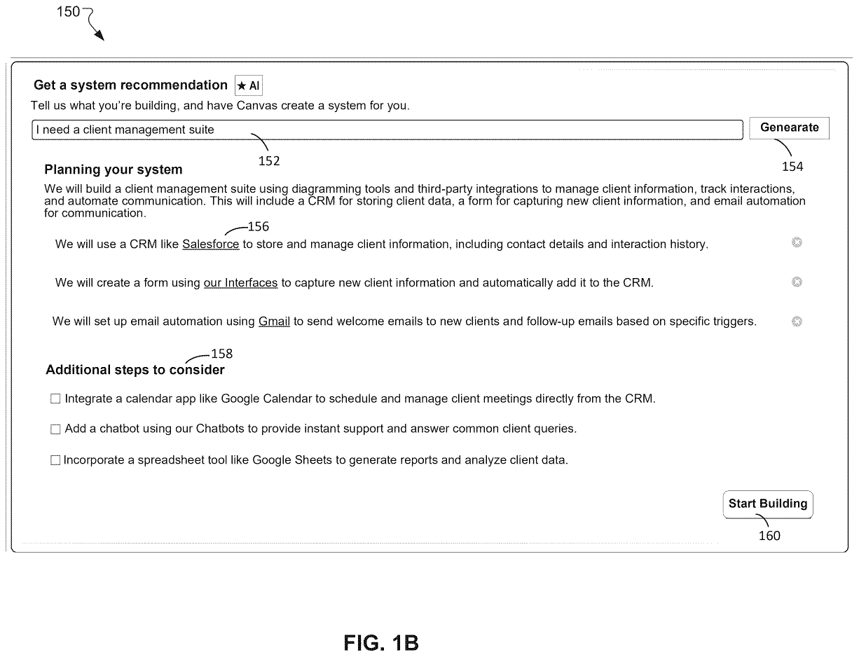

The present system uses the AI-powered diagramming tool to address the gap in visualizing and managing comprehensive systems that extend beyond singular automation workflows, tables, or interfaces. Suppose a user has several automations, interface(s), and table(s) that work together to feed insights from separate channels (e.g., email, Slack, interview notes) into a centralized insights hub. The AI-powered diagramming tool described herein can help other users understand how the process works and potentially implement similar processes. The AI-powered diagramming tool will be described in detail below with reference to FIGS. 1A-4G.

### Automation

The present disclosure provides an AI-powered diagramming tool to simplify the process of planning and designing automation workflows by providing a visual diagramming interface to map out automation ideas (e.g., before implementation). In some embodiments, an automated workflow or automation, which links together users'applications, may include two fundamental functions: a trigger and one or more subsequent automated actions.

A trigger is an event (e.g., a new lead, a new subscriber) that starts automation. The trigger sets the automated workflow in motion and starts the configured action. In other words, a task is triggered at one point so that an action is performed at a subsequent point. An action is an event that the user wants the automation to perform after the trigger occurs. Action events vary between different applications and application types. Based on the configuration of trigger and action(s), connections between applications are established and corresponding automated workflow can be initiated to automatically perform tasks on behalf of the user. For example, if a user wants to create an automated flow to send a direct message in Slack every time the user receives a new email in Gmail, the automation may configure the trigger as the new email in Gmail and configure the action as sending the message. In another example, the trigger can be receiving a new record from an inventory tracking application, and the action can be creating a new row in a spreadsheet application. Whenever there is new data from the connected application(s) or service(s), the automation may be initiated (e.g., based on webhook ingesting).

### Elements Types and Visual Representation

The present AI-powered tool for diagramming automation workflows supports multiple element types, each with distinct visual representations to facilitate user comprehension of complex automation workflows. The element types may include, but are not limited to, automation steps, split paths, grouped nodes, interfaces, tables, and connectors.

Automation steps may be visually represented as nodes (e.g., rectangles) displayed on a diagramming interface. Each automation step node may include visual indicators such as an icon representing the associated application or service, a title describing the step's function, and status indicators showing whether the step is configured, active, or requires user attention. Automation steps may be further categorized into automated steps and default steps, with different visual styling to distinguish between steps that execute automatically and steps that require human intervention.

Split paths represent decision points or conditional logic in the automation workflow, which may be visually represented by a distinctive symbol (e.g., a question mark). This visual representation clearly indicates to users that the workflow branches into multiple possible paths based on specified conditions. Each branch emanating from a split path may be labelled with the condition that triggers that particular path.

Grouped nodes, which allow users to organize multiple steps into logical categories, may be visually represented, for example, by a boundary box or container that surrounds the grouped elements. The boundary box may include a label field, and the visual styling of the boundary box (e.g., color, border style) may be customizable to allow users to create visual hierarchies and distinctions between different groups.

Interfaces and tables represent automation assets created or utilized within the workflow, which may be visually represented as distinct node types with specific icons and styling. For example, interface nodes may display an icon representing a form or web page, while table nodes may display an icon representing a database or spreadsheet. These nodes may include summary information such as the number of fields in an interface or the number of records in a table.

Connectors represent the flow of data or control between automation steps, which may be visually represented as lines or arrows connecting the nodes. The connectors may be automatically routed to avoid overlapping with other elements and to create clear, readable diagrams. The visual styling of connectors (e.g., solid lines for data flow, dashed lines for conditional flow) may vary to indicate different types of relationships between steps.

### System Implementation

The present AI-powered diagram tool is designed to help users plan, organize, and streamline their automation workflows. In some embodiments, this tool provides a diagramming interface where users can map out complex processes, integrate automated and manual steps, and optimize workflows for efficiency. In some embodiments, the diagramming interface includes at least one graphical user interface (GUI) with drag-and-drop functionality that enables users to manipulate visual elements representing automation components. The diagramming interface may maintain a real-time synchronization with the underlying automation platform, such that changes made to the visual diagram are immediately reflected in the corresponding automation configurations, and vice versa. This bidirectional synchronization ensures that the visual representation always accurately reflects the current state of the automation system. In some embodiments, the present AI-powered diagram tool may be implemented as a web-based application accessible through standard web browsers, or as a native application on desktop or mobile platforms.

When a user logs into an automation platform with a user account, the user may access the present AI-powered diagramming tool (e.g., from a menu or by visiting a dashboard). FIG. 1A illustrates an exemplary user interface 100 for initiating an AI-powered diagramming tool. The present tool, which is referred to as “canvas” in this example, allows a user to start the diagram and visualization of an automation workflow via AI 102 or from scratch or a template in 104. Upon selecting option 102 to start with AI (e.g., Microsoft Copilot®), the user can describe an automation process the user wants to build (e.g., a lead management process, an onboarding process), and the AI tool/system can create a visual diagram for the process using tables, interfaces, automation workflows, and other applications. However, if the user selects option 104, the present system may start a blank diagram or use one of the existing templates to plan and visualize the automation process. If a template is chosen, a visual diagram for an automation process may be automatically created, and the user can edit the diagram. Otherwise, the user with the selection of “start from scratch” can have full control over his/her automation process using the present AI diagramming tool.

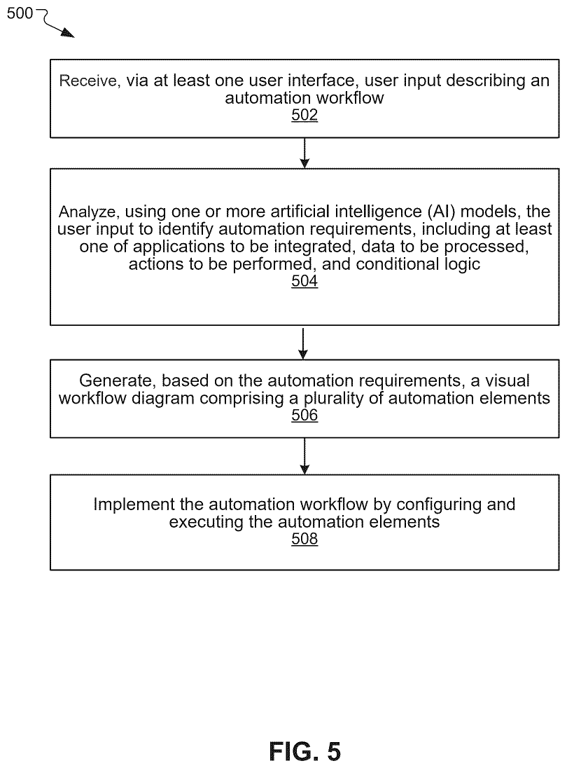

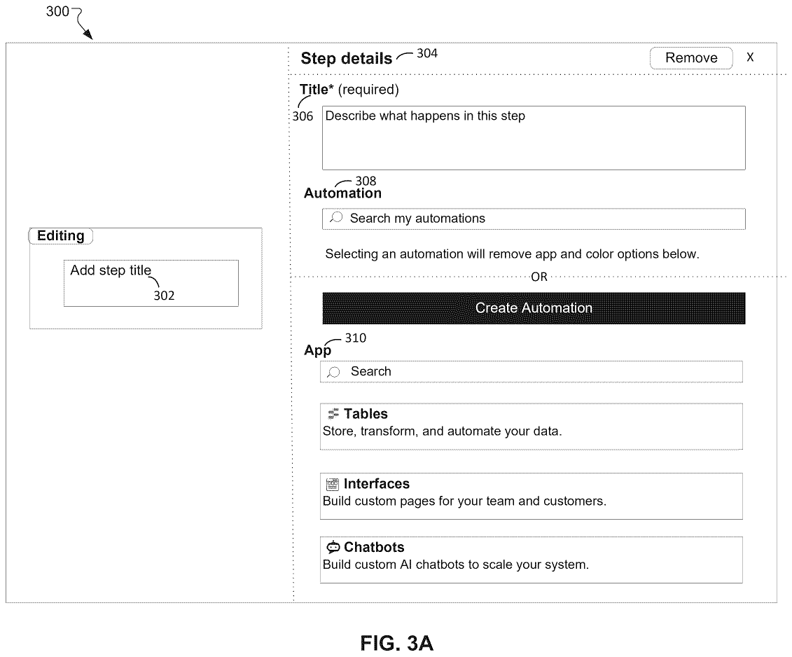

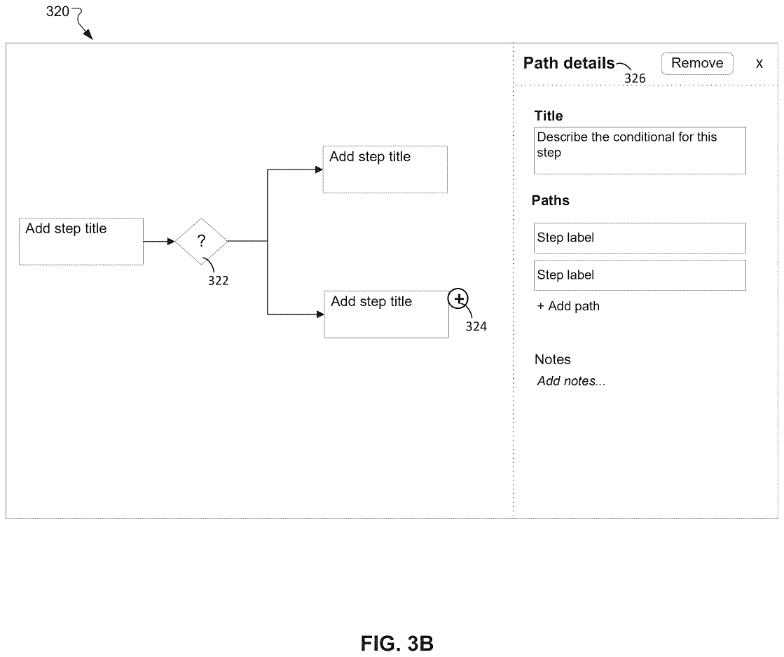

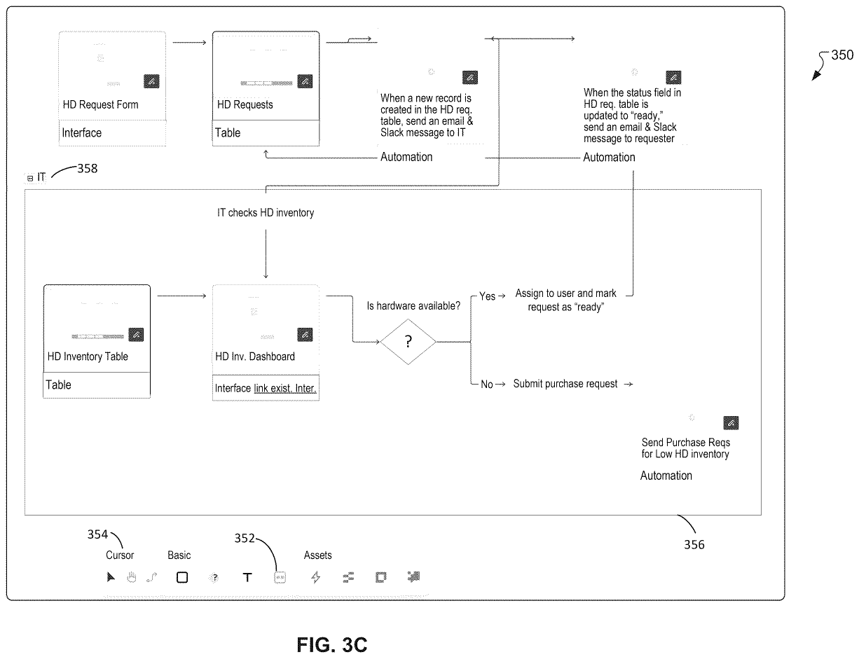

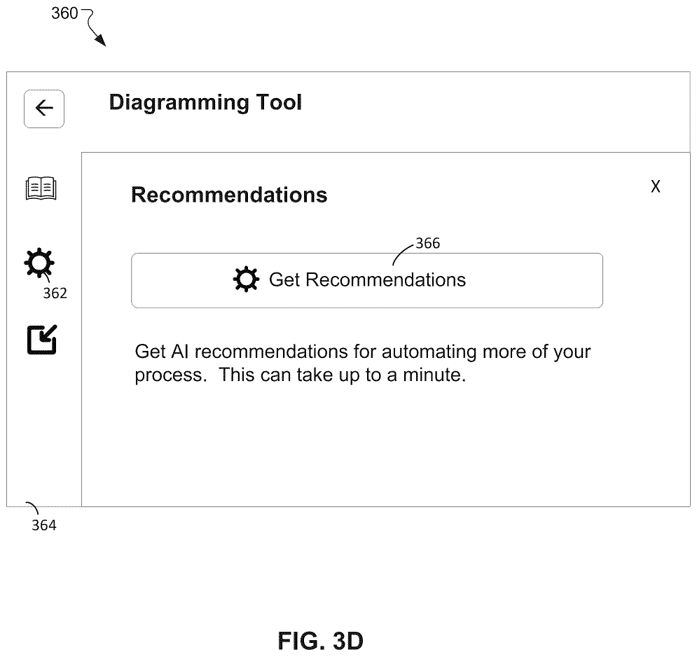

Referring to example GUI 150 of FIG. 1B, it may be presented when a user selects option 102 to use AI to build an automation process. As shown, a dialog box 152 allows the user to describe what to build. The present system may then use AI to generate one or more system recommendations, which the user may review and modify. For example, the user may edit or rewrite the request in dialog box 152 and select a “Generate” option 154 to restart or refine the request, select an underlined application name (e.g., 156) to replace it with a different application, and/or select one or more checkboxes in section 158 to add more steps (described below in FIGS. 3A-3C) to the automation process. In some embodiments, the user can select an area outside the dialog box 152 of GUI 150 to switch to manual operations for creating the automation process. Once the configuration of GUI 150 is complete, the user may select a “Start Building” option 160 to build the automation process.

When working within the AI-powered diagramming tool to build the automation process, the present system may provide at least one interactive interface that allows users to communicate with an AI assistant (e.g., Microsoft Copilot®) at any time. This AI-powered interface may support multiple input modalities to accommodate different user preferences and working environments.

The AI chat interface may include a text input field (e.g., dialog box 152) where users can type and submit requests, questions, or commands related to their automation workflow. This text-based interaction allows users to precisely articulate their requirements and receive contextual assistance from the AI.

Additionally or alternatively, the AI chat interface may support voice-based input through voice recognition technology. In some embodiments, a microphone icon may be provided within the chat interface that, when selected, activates voice recognition capabilities. The users may dictate their workflow requirements, describe desired automation processes, or request modifications to existing diagrams using natural language speech. The present system may apply voice recognition to convert the spoken input into text and process the converted input in the same manner as typed input, providing users with hands-free operation capabilities.

The AI assistant accessible through the chat interface may provide real-time assistance across multiple functions within the automation platform. For example, the AI assistant disclosed herein may help users create new automation workflows, modify existing diagrams, suggest optimizations, configure tables and interfaces, and troubleshoot issues without requiring users to navigate away from the diagramming tool. This integrated approach streamlines the workflow creation process and reduces context switching, thereby improving user efficiency and system performance.

### AI-Powered Asset Builder

The present system may include an AI-powered asset builder feature that automatically converts natural language text descriptions into functional automation assets. Users may type or dictate a description of desired functionality into a step within the diagramming interface, and the AI-powered asset builder may analyze the text description to determine an appropriate asset type and configuration.

For example, if a user types “create a form to collect customer feedback with fields for name, email, and comments,” the asset builder described herein may automatically generate an interface component configured with the specified fields. Similarly, if a user describes “store customer information including contact details and purchase history,” the present system may create a table with appropriate columns and data types. Using the asset builder, the present system may also generate automation workflows, chatbots, or combinations of multiple asset types based on the complexity and requirements described in the user input.

In some embodiments, the present system may employ natural language processing (NLP) techniques and machine learning algorithms to parse and analyze a user-provided description of an automation workflow. The NLP pipeline may perform operations such as tokenization, part-of-speech tagging, named entity recognition, dependency parsing, and semantic role labeling to identify relevant clues within the description. Through this analysis, the AI builder may identify automation requirements by extracting entities such as application or service names (e.g., messaging platforms, ticketing systems, or email services), data types or fields (e.g., customer identifiers, email addresses, timestamps, issue descriptions, or status values), and actions to be performed (e.g., sending notifications, creating or updating records, triggering downstream processes, or modifying data fields). The system may further detect conditional or branching logic expressed in natural language, such as rules for handling high-priority versus low-priority items, exception conditions, or temporal constraints.

The machine learning models used in this analysis may be trained on large corpora of existing automation workflows, workflow templates, and historical user interactions, enabling the models to infer user intent, recognize patterns associated with common automation scenarios, and map natural-language expressions to corresponding automation components. Based on the extracted entities, actions, and conditions, the present system may determine an ordered set of workflow steps, identify required integrations between applications, and select appropriate automation primitives (e.g., triggers, actions, conditions, and data transformations). Based on this analysis phase, the AI-powered diagramming tool or builder may convert unstructured natural-language input into a structured representation of automation requirements, which can then be used to generate functional workflow diagrams with executable automation elements.

This AI-powered asset builder feature significantly accelerates the process of creating automation components by eliminating the need for manual configuration of individual parameters, field definitions, and structural elements. Users can focus on describing what they want to achieve rather than how to technically implement it, thereby lowering the barrier to entry for non-technical users and improving overall productivity for all users.

### AI Prompt Optimization

To maximize the effectiveness of AI-generated automation workflows, the present system may provide guidance to users on creating effective prompts for the AI assistant (e.g., in dialog box 152). Effective prompts may include two key components that work together to provide the AI with sufficient context and specificity to generate relevant automation workflows.

First, an effective prompt may include a broader explanation of the expected end result, describing what the present system will do and who will use it. This high-level context helps the AI understand the overall purpose and scope of the automation. For example, a user might state: “I need a system to manage leads for my sales team” or “Create an order form for my website.”

Second, an effective prompt may offer further details about the important information or steps within the system. These details help the AI determine the specific functionality, data fields, and workflow logic required. For example, following the broader explanation, a user might add: “I want to track leads, assign them to sales representatives, and see the status of each lead” or “This should collect customer information, products, and payment details.”

A user may also specify particular applications he/she already uses (e.g., “send notifications via Slack,” “store data in Google Sheets”), or may allow the AI to suggest suitable applications if none are specified. The present system may support iterative refinement of AI-generated workflows, allowing the user to modify the initial prompt and regenerate the automation diagram multiple times until the AI produces assets and steps that best match the user's requirements. This iterative approach enables users to progressively refine their automation workflows by adjusting the level of detail, changing specific requirements, or adding new components in subsequent prompts. Creating a prompt that matches a user's needs may require several iterations of the instructions, and the user may make as many changes as needed to get the AI to generate the optimal assets and steps for the user's specific use case.

### Automation Asset Creation and Integration

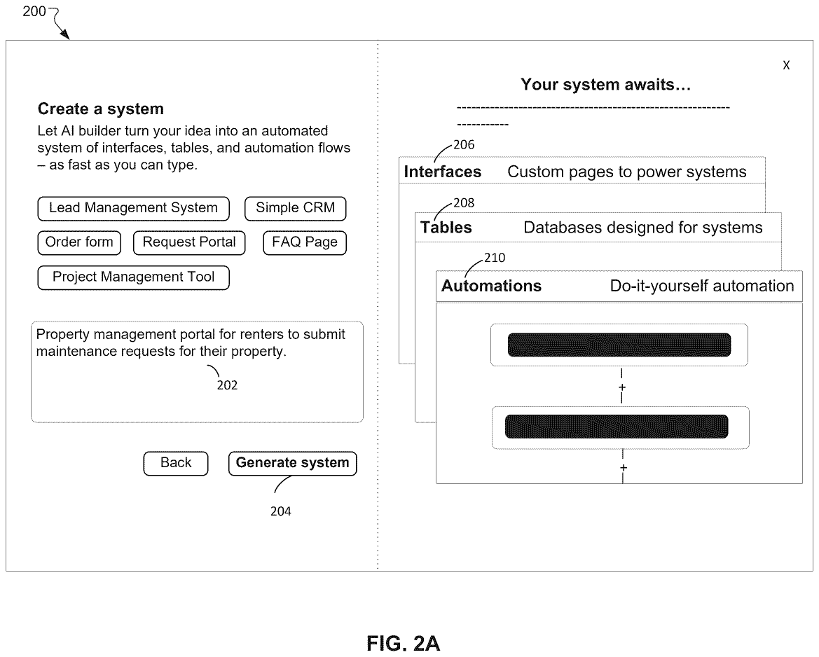

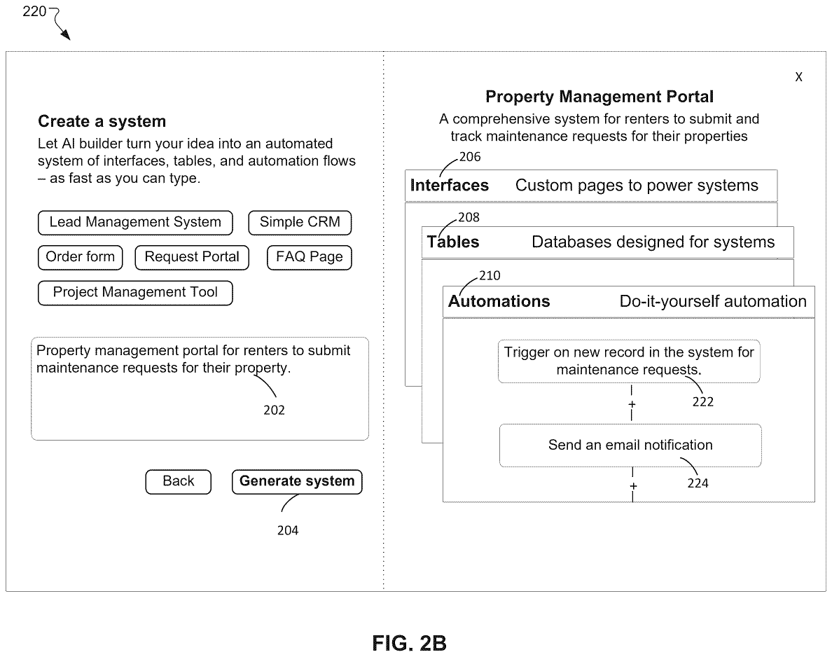

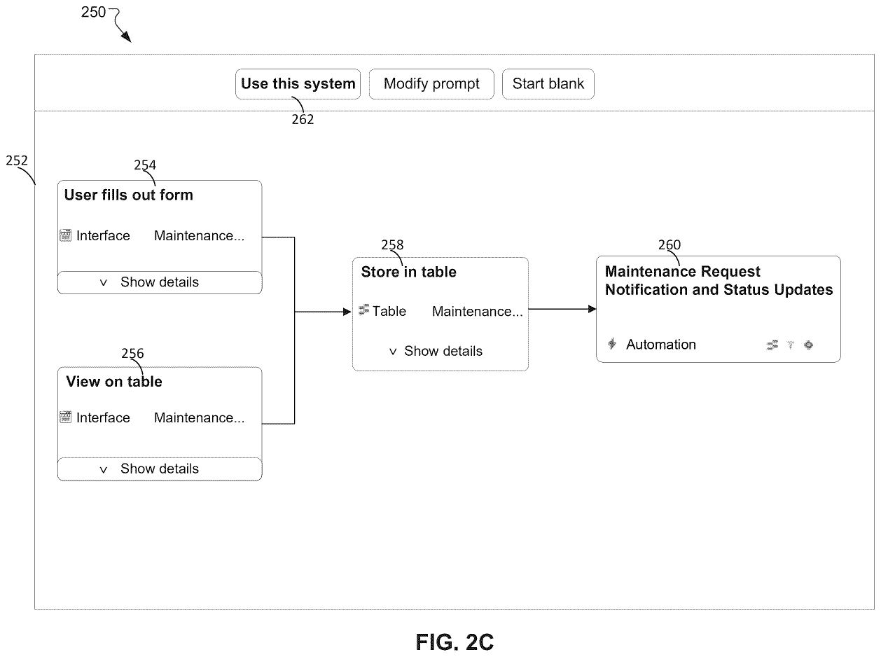

FIGS. 2A-2C illustrate a high-level diagram flow for mapping and visualizing an automation process subsequent to a user selecting to start with AI (e.g., option 102 in FIG. 1). As shown in the graphical user interface (GUI) 200 of FIG. 2A, the user indicates what he/she would like to create in 202, which is “property management portal for renters to submit maintenance requests for their property.” The user can then select “generate system” in 204. In response, the present AI tool may create a visual diagram for this property management portal automation process. This diagram not only shows a visualization of the user's automation plan, but also adds the automation assets to support the diagrammed process, such that the automation plan can be transformed into automated action(s) in real time. The automation assets or building blocks include at least interfaces 206, tables 208, and automation workflows 210. Interfaces 206 can be used to build custom pages, and the tables 208 can be used to store, transform, and automate data used in an automation diagramming process.

FIG. 2B includes a GUI 220 showing that the AI tool is building the automation process of “property management portal.” For example, the AI tool may update the automations 210 to include a trigger 222 and an action 224, which indicates that, whenever a new record (e.g., a maintenance request) is received in 222, an email notification will be sent out in 224.

The resulting diagram 252 that visualizes each step of the automation “property management portal” is depicted in a GUI 250 of FIG. 2C. According to diagram 252, when a user (e.g., a renter) fills out a form (e.g., a maintenance request form) in 254, this form may be viewed and stored in table(s) as shown in 256 and 258. This stored form can be a new record that triggers the actions in 260, which include sending out the maintenance request notification and updating a maintenance status. If the user is satisfied with this automation process diagramming, the user can choose “use this system” in 262 to immediately turn this diagram into automation for an implementation. This implementation would allow the user to actually receive a notification when someone submits a maintenance request, thereby meeting the user's goal (e.g., described in 202 of FIG. 2A).

In the example of FIGS. 2A-2C, the trigger event (e.g., filling a form) may occur in a first application, and the actions (e.g., emailing notification, updating status) may be performed in a second application and/or a third application. The trigger and actions are connected through the interfaces, tables, and other functional blocks provided by an automation platform integrated with the present system. Through the AI-powered diagramming tool of the present system, each step and element associated with the trigger, the actions, and the connections are clearly illustrated in a visualized diagram, such that the requesting user as well as other users (e.g., teammates, viewers) may view, share, and collaborate on this diagram to optimize an automation process. More importantly, the visual diagram of an automation process provided by the AI-powered diagramming tool of the present system can be turned into implementing automation, and this automation matches the requesting user's original vision and goal included in the space (e.g., GUIs) of the diagramming tool.

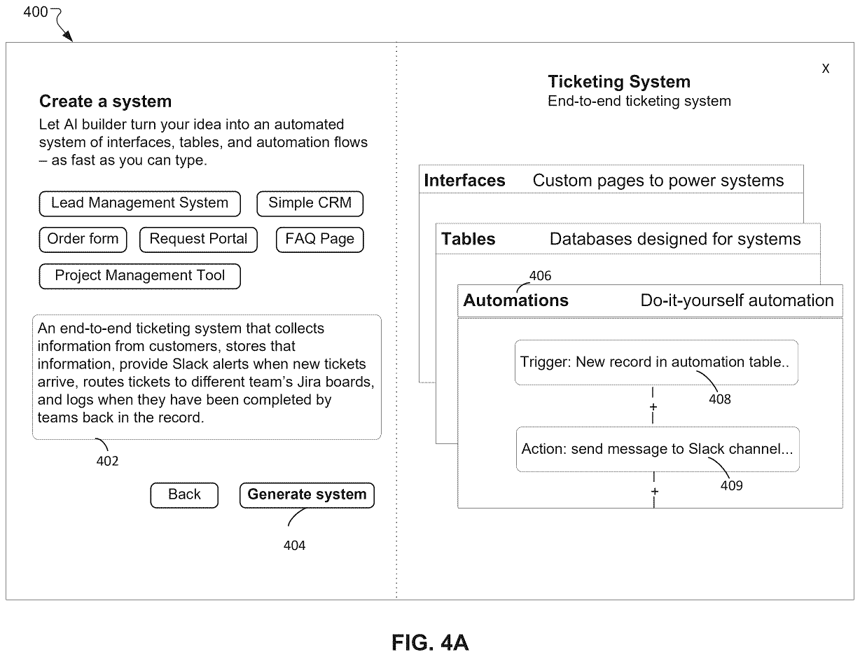

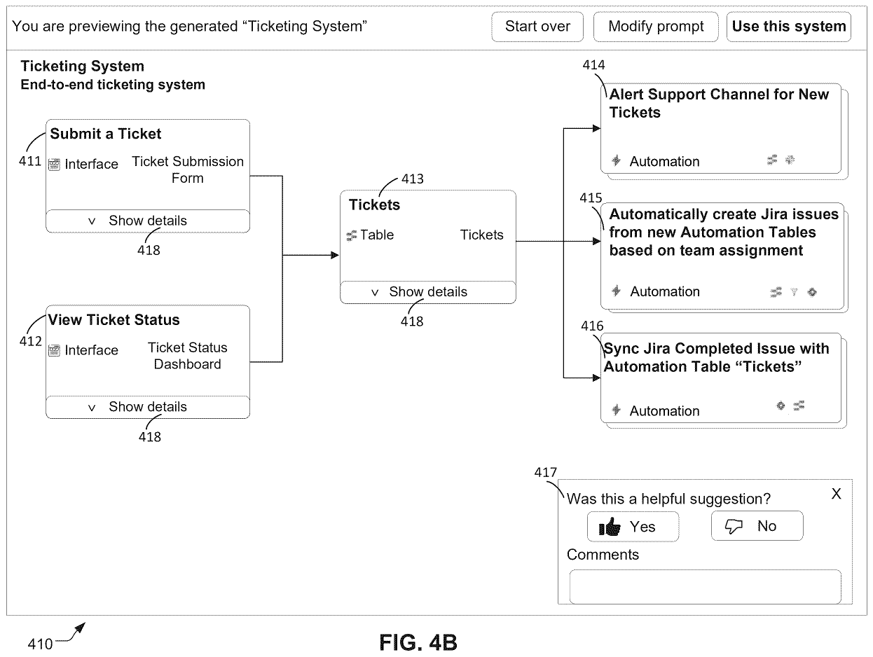

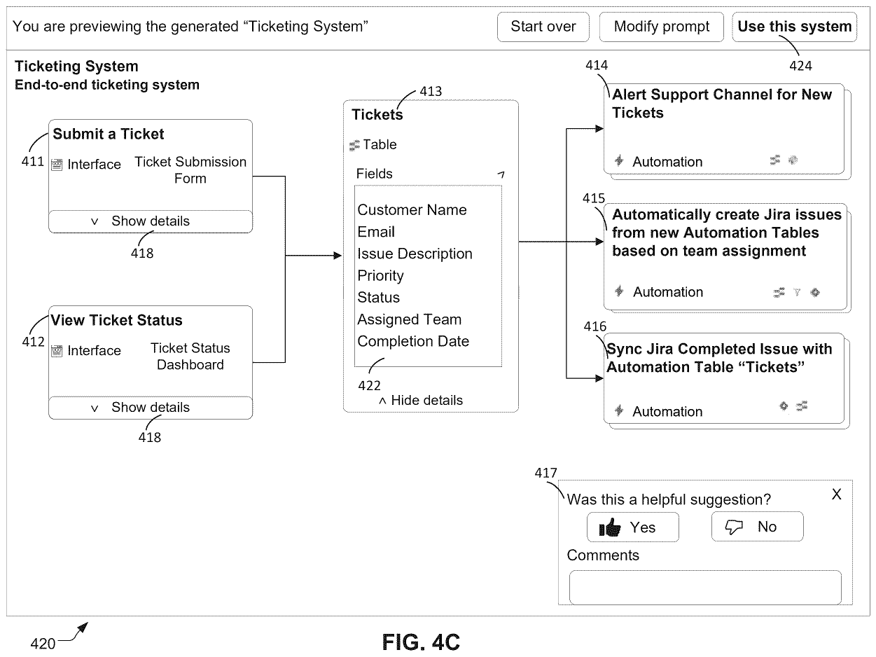

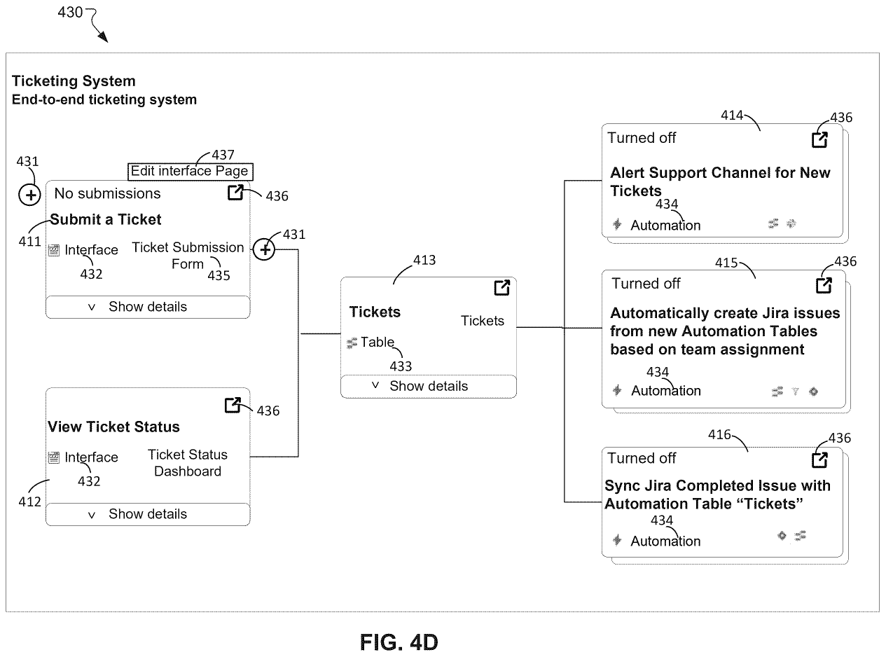

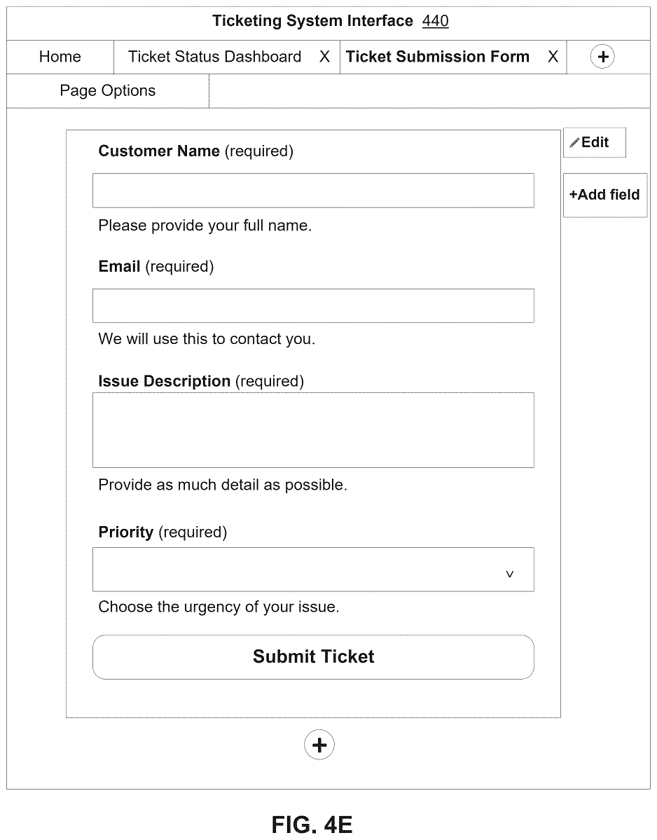

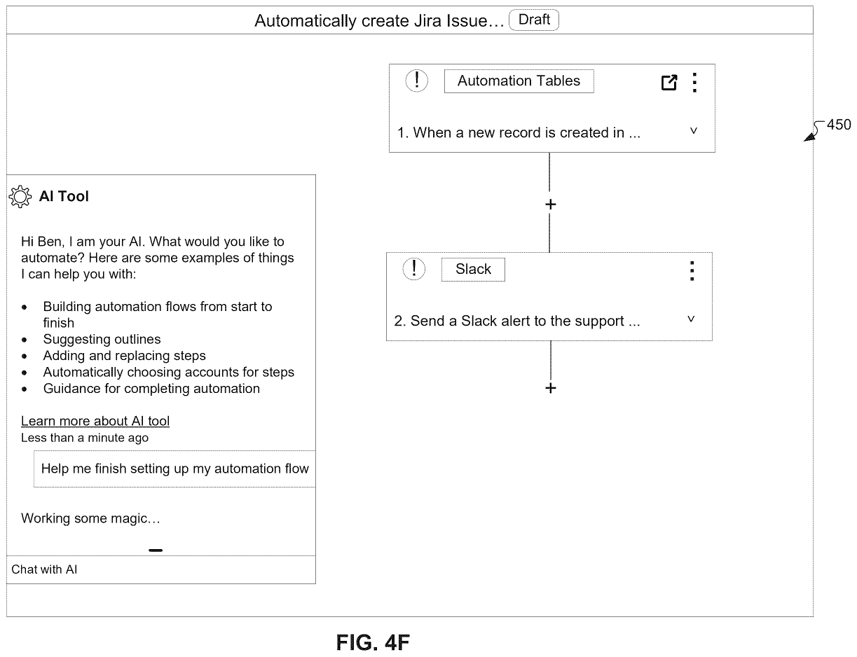

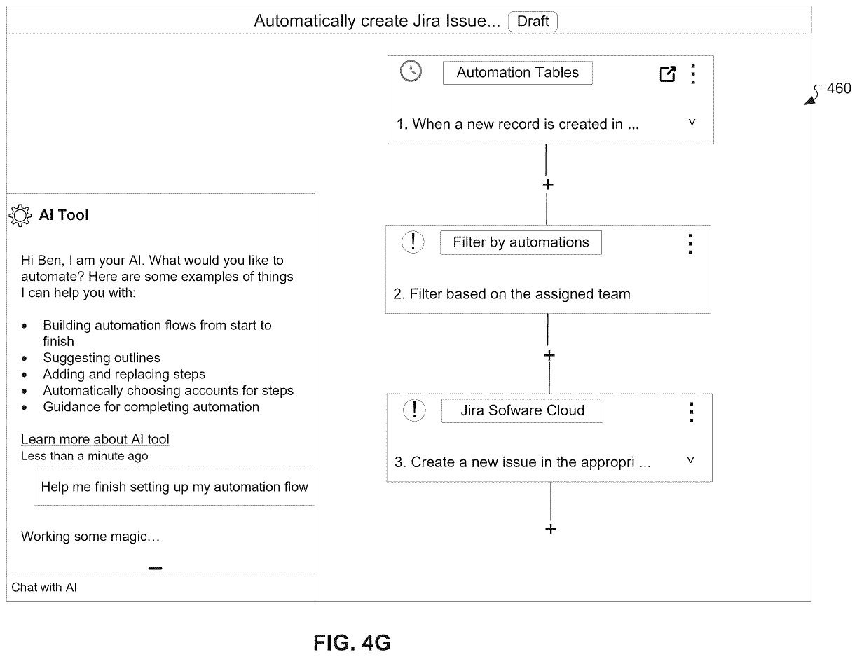

It should be noted that the automation workflow in the example of FIGS. 2A-2C is created by the user effortlessly since all the input from the user is a goal description (other than a few button clicks). Once receiving the information about what the user wants to automate, the present diagramming tool can automatically create the structure for the user. No manual building is required. In this example, the present diagramming tool may detect and apply an existing template when creating diagram 252, thereby minimizing manual operations. In other scenarios, using the AI-powered diagramming tool described herein, users may collaborate to edit an automation diagram (even if an existing template is used), add steps and/or connections to the diagram, or start diagraming an automation process from scratch, which will be detailed below in FIGS. 3A-4G.

### Diagramming Operations

Once a user has chosen the way (e.g., starting with AI 102 or starting from scratch or template 104 in FIG. 1) to create an automation process, the present system may allow a user to perform diagramming operations using the AI-powered diagramming tool. These diagramming operations include adding steps, connecting steps, moving steps, collaborating on processes, etc.

Some example diagramming operations are shown in FIGS. 3A-3D. If a user chooses to start from scratch (e.g., 104 in FIG. 1), the user may need to add steps to create his/her custom automation process diagram from a blank page. If the user chooses to start with AI (e.g., 102 in FIG. 1), the user may still want to make changes to the displayed diagram (e.g., generated based on an existing automation). Either way, the user may be allowed to add steps as shown in an example GUI 300 of FIG. 3A. In some embodiments, the user may add new steps to an automation process by clicking the “+” icon that appears whenever the user hovers over an existing step (as described below in FIG. 4D).

In the present diagramming tool, each step corresponds to a part of an automation process that requires action from the user, other users (e.g., teammates), or applications. Different step types ensure that various aspects of the diagramming process can be captured. As depicted in FIG. 3A, the user may select “adding a step title” in 302 and open a “step details” sidebar 304 to fill in the information for this default step. A default step is used for actions that need input from a user or a team. For example, the present diagramming tool may prompt the user, in sidebar 304, to describe what this specific step does in a required “title” field 306, to select an existing automation or create a new automation in an “automation” field 308, and to select the application (if any) where the action happens in an “application” field 310. While it is not shown in FIG. 3A, the user may also use the sidebar 304 to add the user or team that is responsible for this step, include an estimate of how long it takes to perform this task manually, add any extra information related to this step, etc. Not all steps are default steps. The present system supports many automated steps, which are steps that have already been automated through automations, such as sending emails, updating spreadsheets, etc. The automated steps may make the entire automation process flow more smoothly.

In addition to adding steps, the present diagramming tool also allows a user to split paths by clicking the “+” icon next to an existing step. The split path operation allows the user to add decision points that lead to different scenarios, depending on the contents or results of the previous step. For example, if one action leads to success, it goes down one path. If not, it takes another route. In this way, one step may be connected to multiple outcomes.

The split path may be visually represented in the diagram by a distinctive symbol to clearly indicate decision points in the workflow. This visual representation helps users quickly identify conditional logic within their automation processes and distinguish decision points from linear sequential steps. As shown in an example GUI 320 of FIG. 3B, the “split path” is represented by a question mark within a diamond shape in 322.

The user can add one or more paths to one split path using the “+” icon in 324. Each path represents a possible outcome based on different conditions. For example, in an automation workflow that processes customer support tickets, a split path might branch into “high priority” and “low priority” paths based on the urgency indicated in the ticket.

When a user adds or selects a path within a split, the present system may display a “path details” sidebar 326. The path details sidebar provides input fields for configuring the conditions that determine when that particular path is taken. The sidebar may include a title field where the user can enter a descriptive label for the path (e.g., “High Priority,” “Low Priority”), and a conditional logic field where the user can specify the criteria that must be met for the path to be activated.

The conditional logic may be specified using various methods, for example, selecting a field from a previous step and specifying a comparison operator and value (e.g., “Priority equals High”), using a formula or expression language to define complex conditions, or using natural language that is parsed by the AI system to determine the appropriate conditional logic.

Each path emanating from a split path may be visually represented by a connector leading to subsequent steps. The connectors may be labelled with the path title or condition to provide clarity. The present system allows users to add steps to each path independently, creating distinct workflow sequences for different scenarios. The split path structure allows for sophisticated automation workflows that can handle multiple contingencies and adapt to varying input conditions.

The present diagramming tool makes user operations (e.g., adding steps, split paths) easy and organized. Multiple steps can be added, and paths can be split to create different outcomes based on what happens at any point. Steps can be grouped together, such that even the most complex workflows stay clean and easy to understand.

In some embodiments, the present system may use grouped nodes to organize steps and automation workflows into categories to simplify complex workflows. This can be particularly useful if workflow elements (e.g., steps, automation workflows, tables, interfaces) are related to a specific project or are the responsibility of a specific team. In some embodiments, a user may use a tool icon in a diagramming interface to drag the elements into a group. The user may also add or modify group labels (e.g., by entering a descriptive name for a group) to help other users and collaborators quickly understand the purpose and contents of each grouped section within a complex workflow diagram.

In some embodiments, the present system allows a group to be moved as a single unit in response to a cursor movement, such that all elements within the group move together while maintaining their relative positions. Workflow elements may also be added to or removed from an existing group. When a group is deleted, the elements previously contained within the group remain unaffected and retain their current positions. This functionality enables users to reorganize workflow structures without losing or disrupting individual components.

FIG. 3C illustrates an example GUI 350 of group creation and manipulation operations. A user can select a group tool icon 352 and drag cursor 354 over multiple workflow elements to create a group. The resulting group is associated with a boundary box 356 and has an editable label “IT” in 358. The workflow elements can be added to and removed from the group.

The present system may further provide on-canvas field mapping functionality that enhances diagramming operations by enabling users to map inputs and outputs directly within the diagramming interface. This feature allows users to configure data flow between automation steps without navigating to separate editing interfaces or external applications. For example, when connecting two steps in the automation workflow, users may select which data fields from a first step should be passed as inputs to a second step by using drag-and-drop operations or selection menus displayed directly on the canvas. This on-canvas mapping capability maintains the user's focus on the overall workflow structure while simultaneously allowing detailed configuration of data relationships, thereby streamlining the workflow configuration process and reducing the time required to build functional automations.

### Example AI-Powered Operations

Instead of manually adding and mapping workflow elements (e.g., steps, applications), a user may choose to use AI to build an entire automation workflow or selected portions thereof. The user may initiate the workflow creation process using AI from the outset, for example, by selecting option 102 in FIG. 1A and proceeding as shown in FIG. 1B. Alternatively, during the workflow construction process, if the user is unclear about what to automate next, the present diagramming tool may provide the user with AI-powered suggestions based on what the user has already built, as shown below in FIG. 3D.

The AI-powered recommendation feature may analyze the existing steps within the user's diagram to generate contextually relevant suggestions. By reviewing the current workflow structure, including the types of applications used, the data being processed, and the logical flow of steps, the AI-powered diagramming tool can identify logical next steps, potential optimizations, or missing components that would enhance the automation process.

When the AI-powered diagramming tool generates a step suggestion, the suggested step may be displayed within the diagram with user interface controls that allow the user to accept or reject the suggestion. If the user accepts the step suggestion, the user may subsequently edit the step to modify parameters, change the application associated with the step, or adjust the position and connections within the automation workflow/process.

As shown in an example GUI 360 of FIG. 3D, the user may click an icon 362 on a summary panel 364, and the present diagramming tool may provide the user with a “get recommendations” option 366 to obtain AI-powered recommendations. The present diagramming tool may analyze the user's existing process and provide AI-powered recommendations to automate and improve the workflow. This feature will also be described below in FIGS. 4F and 4G. In some embodiments, the present diagramming tool may also track the time the users'automation saves, clearly picturing the efficiency of the computer and network system resulting from the user's automation.

In some embodiments, the present system may include agents or AI-powered assistants configured to perform tasks autonomously within an automation workflow. Agents may be capable of making decisions, processing information, and executing actions without requiring explicit step-by-step instructions from users. For example, an agent/AI-powered assistant may review data in a table, determine whether specific conditions are met, and automatically route information to appropriate team members or applications based on predefined criteria or learned patterns.

The present system allows users to add and configure agents directly within the diagramming interface without leaving the environment. When adding an agent to a workflow diagram, the present system may instruct users to specify the agent's purpose, define its decision-making parameters, and connect it to other steps in the automation process using the same drag-and-drop interface used for other automation components. This seamless integration of agent-based automation into workflow diagrams allows users to create sophisticated, intelligent automation processes that can adapt to varying conditions and make contextual decisions, thereby reducing the need for complex conditional logic and manual intervention.

An important AI-powered diagramming operation is collaboration. There is no more going back and forth on email trends or spreadsheets between users and/or teammates since all the tasks and actions can be completed in a single space of the present diagramming tool, where all the users leave comments, make adjustments, and fine-tune the process in real time.

In some embodiments, the present AI-powered diagramming tool includes core collaboration features such as sharing, commenting, and live cursors. A user may share an automation process in multiple ways, for example, by sharing an automation process diagram with other users so that others can add comments and tag users. In some embodiments, a user may invite specific users or teams to share the diagramming of the automation process. The user may select either editor(s) or teammate(s) such that they can collaborate with the user to make changes to the user's diagramming process. The user may also select viewers to only view the user's live diagramming process. In other embodiments, a user may share the diagramming process with others using public links and downloads. The present system may generate a public link for a requesting user, and this link may provide other users or any users with access to that link. The link may provide a view-only experience, so that others can only see a user's live diagramming process but cannot edit the process. This is helpful when the user wants to share a source of truth for how an automation process is working with recipients, regardless of these recipients'identities. Additionally or alternatively, a user may also collaborate with others using a downloading and sharing option. This is useful if the user wants to include a point-in-time snapshot of an automation diagramming process and share the process, for example, in a presentation.

The present AI-powered diagramming tool also supports a commenting feature. Commenting is useful for discussions with teammates, whether to seek approval on a proposed process, leave a note about a potential problem, or ask for help. For example, if users A and B are discussing part of a diagramming process, user A can comment “@ user B: Can you please review this step?” in a comment area of one or more GUIs provided by the present diagramming tool. In response, user B can get an email notification alert so that user B can easily return back into the diagramming tool for discussion.

Comments may support rich text formatting, allowing users to emphasise important points using bold or italic text, create bulleted or numbered lists, and include hyperlinks to external resources. The @mentions allow users to tag specific collaborators. When a user is @mentioned in a comment, the user may receive a notification (e.g., via email or in-application alert) to request the user's attention. The notification may include a link that, when selected, navigates directly to the commented element within the workflow diagram.

The comments can be added to specific elements within a workflow diagram, such as individual steps, split paths, or grouped nodes. Additionally, users may add free-form annotations to the workflow diagram using text boxes or drawing tools. These annotations may be used to add explanatory notes, highlight important sections, or provide context that is not tied to a specific element.

A live cursor can be applied in the present AI-powered diagramming tool for collaboration. This is useful because a user can easily know what other users are active in the user's diagramming tool space and where the other users are working. This helps facilitate real-time collaboration.

When multiple users are viewing or editing the same workflow diagram concurrently, the present system may display live cursors representing the position and activity of each user. Each user's cursor may be visually distinguished by a unique color and may be labelled with the user's name or initials. As a user moves their cursor across the canvas, the corresponding live cursor is updated in real-time for all other users viewing the diagram. This provides immediate visual feedback about where each collaborator is focusing their attention.

When a user selects an element (e.g., a step, split path, or grouped node), the present system may display a visual indicator (e.g., a colored outline or highlight) around that element in the color associated with that user. This indicates to other collaborators that the element is currently being edited or examined. If another user attempts to edit the same element simultaneously, the present system may display a notification indicating that the element is currently being edited by another user, and may provide options to wait for the other user to finish, request that the other user release the element, or view the changes being made in real-time.

The present system may implement operational transformation or conflict-free replicated data type (CRDT) algorithms to ensure that concurrent edits by multiple users are properly merged and that the workflow diagram remains in a consistent state. When conflicts arise (e.g., two users simultaneously modify the same property of an element), the present system may apply conflict resolution rules (e.g., last-write-wins, or prompting users to manually resolve the conflict) to determine a final state.

In some embodiments, the real-time collaboration features may be implemented using WebSocket connections or similar real-time communication protocols that enable low-latency bidirectional communication between the client applications and the server. The present system may maintain a shared state representation of the workflow diagram on a server, and may broadcast updates to all connected clients whenever changes are made.

Overall, the collaboration feature of the present AI-powered diagramming tool can help users gain alignment on processes internally and improve the efficiency of automation workflow processes.

### Additional Diagramming Operations and Keyboard Shortcuts

A user can perform other diagramming operations in the space (e.g., GUIs) provided by the present diagramming tool. These operations include, but are not limited to, connecting existing steps, moving steps, deleting steps, deleting a diagram, adding text anywhere on the process diagram, zooming in and out to fit the diagram to a page, cleaning up the layout to straighten connectors and order steps, etc.

The present AI-powered diagramming tool may provide zoom controls that allow a user to focus on the details or zoom out to see the entire workflow at a glance. For example, a user may zoom in and out using a first set of keyboard shortcuts, while scrolling by holding another key or using a scroll function. The user may also press a third set of keyboard shortcuts to automatically fit the entire diagram to a viewable area.

The present AI-powered diagramming tool may also provide a cleanup layout function that will automatically straighten connectors and order steps based on their connections and a starting point of the process, making the layout appear neat and organized. For example, a user may activate the cleanup function by selecting a cleanup layout button in a diagramming interface or by using a keyboard shortcut. When the cleanup layout function is activated, text boxes may be excluded from the reorganization process and remain in their original positions, ensuring that annotations, titles, and descriptions added by the user maintain their intended placement relative to the diagram.

The present system may provide additional keyboard shortcuts to enhance user efficiency when creating and editing automation diagrams, such as undo, redo, and element deletion, etc. In some embodiments, a help icon (e.g., a question mark symbol) may be provided in the user interface, which when selected, displays a complete list of available keyboard shortcuts, providing users with quick access to shortcut information to quickly learn and utilize efficiency-enhancing shortcuts without leaving the diagramming interface.

In some embodiments, when a user adds automation workflows to a diagram, the present system may allow the user to control the visibility of individual steps within those workflows. A toggle switch or control may be provided for each automation workflow that allows the user to show or hide the detailed steps of that workflow. When the toggle is set to hide steps, the automation workflow may be displayed as a single consolidated element showing only high-level information such as the workflow name, trigger type, and number of actions. When the toggle is set to show steps, the automation workflow may expand to display each individual step including the trigger, all actions, and any conditional logic or split paths.

This step visibility feature enables users to control the level of detail displayed in the diagram based on their current needs. For example, when presenting a high-level overview of a complex system, the present system may hide detailed steps to maintain focus on the overall process flow and relationships between major components. Conversely, when troubleshooting a specific automation or configuring detailed parameters, the present system may show the steps to access and modify individual components. This flexibility allows the same diagram to serve multiple purposes and audiences, from overall summaries to technical implementation guides.

In some embodiments, the present system may also allow users to apply automatic layout organization to a subset of steps rather than the entire diagram. A user may select specific steps using a selection tool (e.g., by clicking and dragging to create a selection box around desired steps, or by holding a modifier key such as Shift or Cmd/Ctrl while selecting individual steps), and the present system may provide options to organize the selected steps in a specific direction. For example, users may choose to organize selected steps horizontally (e.g., from left to right) or vertically (e.g., from top to bottom).

This selective layout feature may allow users to maintain control over different sections of complex diagrams while still benefiting from automatic organization. For example, a user may organize a series of sequential processing steps horizontally to show progression through time, while organizing parallel notification steps vertically to show simultaneous actions. By applying different layout orientations to different sections of a diagram, the present system may create intuitive and readable visualizations that reflect the logical structure of a user's automation process.

The present system may also provide a variety of formatting options for customizing the appearance and content of text elements. For example, the present system may allow users to create hierarchical text elements such as headings, subheadings, and body text; modify text fonts and colors to visually distinguish different types of information; and add hyperlinks to indicate interactive content. Hyperlinked text may itself be visually distinct, for example, through color, underlining, or other visual cues. The present system may further provide options for creating bulleted lists, numbered lists, or task lists with checkboxes, enabling users to present information in structured and easy-to-read formats.

Additionally, the present system may allow users to add images to text boxes by dragging and dropping image files from a local device or directly from webpages into the text box area. This drag-and-drop functionality simplifies the process of adding visual elements such as logos, screenshots, diagrams, or icons to enhance the clarity and presentation of automation workflow diagrams. These formatting options enable users to create professional, visually organized diagrams that effectively communicate complex automation processes to diverse audiences.

### Ticketing Workflow Implementation

Referring now to FIGS. 4A-4G, another example of generating a ticketing system automation process is illustrated. In this example, the process is initiated as a result of a user selecting to start with AI (e.g., Microsoft Copilot®). Compared to the example in FIGS. 2A-2C, where a user also chooses to set up and implement an automation workflow of a property management portal using AI, this example is used to further illustrate some diagramming operations supported by the present AI-powered diagramming tool.

A user's automation process may be diagrammed and then turned into an automated system with AI assistance. As shown in an example GUI 400 of FIG. 4A, the automation process is described as “an end-to-end ticketing system that collects information from customers, stores that information, provides Slack alerts when new tickets arrive, routes tickets to different teams'Jira boards, and logs when they have been completed by teams back in the record” in 402. In some cases, this description is the only manual input from a requesting user. In other cases, the user may also perform some diagramming operations to customize his/her automation as shown in this example. Here, upon the user selecting “generate system” 404, a ticketing system may be planned, diagramed, mapped out, and presented to the user. For example, the present diagramming tool may update automations 406 to include a trigger 408 of “new record in automation table” and set up “send message to Slack channel” as an action 409 during this live diagramming of the ticketing system.

A “ticketing system” automation diagram is generated for preview by the user. As depicted in an example GUI 410 of FIG. 4B, this automation process diagramming may include six steps 411 through 416. When a user submits a ticket in step 411, this ticket status can be viewed in step 412. Steps 411 and 412 can then be connected to step 413 (e.g., based on a conditional logic), where the submitted ticket is stored in ticket table(s). For example, if the ticket is new, this ticket is stored in step 413. The new ticket may serve as a trigger of “new record in automation table” (e.g., trigger 408 in FIG. 4A) to initiate the actions in steps 414, 415, and 416. These steps correspond to the user's goal description (e.g., “routes tickets to different teams'Jira boards, and logs when they have been completed by teams back in the record” in 402 of FIG. 4A).

In some embodiments, the present AI-powered diagramming tool may generate the visual diagram of the automation process (including steps 411-416) based on existing automation workflow(s), interfaces, tables, and applications. The generated visual diagram is presented as a suggestion to the user, and the user may comment on this suggestion in 417. The user may select “show details” options 418 in steps 411, 412, and 413 to view the parameter details associated with each step. For example, in response to the user selection of option 418 in step 413, an example GUI 420 of FIG. 4C may be generated to show parameters associated with this step. Step 413 is storing tickets in table(s), and the corresponding parameters include at least customer name, email, issue description, priority, etc., in fields 422. The user may also select “use this system” 424 in FIG. 4C to turn this automation process diagram into an automation for modification and implementation, as shown in FIG. 4D.

An example GUI 430 of FIG. 4D includes “+” icons 431, which, when selected by a user, may cause the present diagramming tool generate one or more GUIs and instruct the user to add step(s) or split a path (as described in FIGS. 3A and 3B). It can also be seen from FIG. 4D that steps 411 and 412 are created using interfaces 432, step 413 is created using a table 433, and steps 414, 415, and 416 are created using automations 434. For example, step 411 may be created using an interface 432 labeled as “Ticket submission Form” 435. The AI-powered diagramming tool allows a user to enter or modify the data relevant to interfaces, tables, and automations. For example, when the user hovers over an icon 436 of step 411 in FIG. 4D, a text prompt 437 “Edit interface page” may appear to notify the user that he/she may edit this step 411 in an interface page. Upon the selection of this icon 436, a ticketing system interface 440 may be generated and shown in FIG. 4E, where the user can input or modify the “Ticket submission Form” 435 associated with step 411 through the fields including customer name, email, issue description, and priority.

In another example, if the user selects icon 436 of step 414 in FIG. 4D, an example GUI 450 in FIG. 4F can be generated to include the automation used to create step 414. As depicted, this automation includes a trigger 452, an action 454, and the relationship between the trigger and action. An AI tool 456 (e.g., Microsoft Copilot®) may also be provided to the user to help the user finish setting up the automation flow, for example, adding one or more actions using the “+” icon in 458. Similarly, if the user selects icon 436 of step 415 in FIG. 4D, an example GUI 460 in FIG. 4G can be generated to include the automation used to create step 415, where the user can use the AI tool to edit and customize the automation flow.

In addition to using AI (e.g., 102 in FIG. 1) to organize and diagram an automation process, a user may also choose to start this process from scratch (e.g., 104 in FIG. 1). The user may start a blank automation workflow diagramming by adding steps, splitting paths, connecting steps, asking for AI suggestions, etc. These operations have been discussed above, and will not be repeated again for brevity and clarity.

The present system may implement data retention, deletion, and export policies that vary depending on the specific product or feature being used within an automation platform. These policies ensure compliance with applicable data protection regulations and provide users with control over their automation workflow data. For example, data associated with automation workflows, tables, and interfaces may be retained for different periods based on the data type, user subscription level, and regulatory requirements. The present system may provide users with tools to export their automation diagrams, workflow configurations, and associated data in standard formats for backup, migration, or archival purposes. The present system may also provide mechanisms for users to request deletion of their data in accordance with data protection regulations (e.g., general data protection regulation (GDPR).

### Performance Monitoring

Once an automation process is complete and the corresponding automation is activated for implementation, the present system may provide users with performance statistics or metrics associated with the automation assets over time. These statistics and metrics enable users to assess the effectiveness of their automation workflows and identify opportunities for optimization.

The performance statistics may include metrics related to automation workflows, tables, and interfaces. For example, for automation workflows, the metrics may include a total number of times (e.g., runs) the workflow has been executed, a success rate (e.g., a percentage of runs that completed without errors), an average execution time per run, a total time saved by automating the process (e.g., calculated by multiplying the number of runs by the estimated time required to perform the task manually), and error rates and types of errors encountered.

For tables, the example performance statistics and metrics may include an amount of records stored in a table, a rate of record creation over time, a distribution of values in specific fields (e.g., the number of high-priority vs. low-priority tickets), and an average time between record creation and completion or resolution.

For interfaces, the example performance metrics may include a total number of submissions received through an interface, a completion rate (e.g., a percentage of users who started filling out the interface form and successfully submitted it), an average time users spend completing an interface form, and the most common sources of errors or validation failures.

The present system may provide these statistics and metrics through a dashboard or summary panel that is accessible from within the AI-powered diagramming tool. The dashboard may include visualizations such as charts, graphs, and tables that make it easy to understand trends and patterns. For example, a line graph may show the number of automation workflow runs over time, a pie chart may show the distribution of ticket priorities, and a summary card may display the total time saved by the automation.

The performance statistics may be calculated and updated in real-time or near-real-time, providing users with current information about the state and performance of their automation system. In general, these statistics and metrics provide an overview of how the computer and network resources are being saved with an automation.

### Advanced Workflow Cases

Other than the examples discussed in this disclosure, the present system can be applied in numerous use cases across different practical functions, such as in lead capture processes, customer support scenarios, employee onboarding workflows, etc. For example, in employee onboarding workflows, new employee information may be collected from a human resources application, tasks may be automatically created and assigned to various departments (e.g., IT for equipment setup, HR for documentation, managers for training schedules), and progress may be tracked in a centralized table with automated reminders sent for incomplete tasks. These examples demonstrate the integration of interfaces, tables, agents, automation workflows, and multiple third-party applications within single automated processes visualized and managed through the present diagramming tool.

In general, anytime complex workflows slow down progress and make scattered tools, making system operation and documentation more complicated than they need to be, the present system can be applied to visually map the entire process and automate the process at the same time. The AI-powered diagramming tool described herein maps out everything (e.g., from how the applications connect to how teams work together) and turns these plans into automated actions, all in one place. This tool helps users visualize, plan, and automate their critical workflows, making the workflow and computer/network system operation run smoother and faster.

Importantly, the present AI-powered diagramming and automation system may provide technical benefits by improving how computing resources are coordinated, monitored, and utilized across complex automated processes. By representing automation logic as structured, machine-interpretable workflow diagrams, the present system enables more efficient orchestration of distributed components, reduces redundant processing, and minimizes unnecessary execution paths. The AI-assisted generation and modification of workflows allows the present system to dynamically identify dependencies, optimize execution order, and avoid superfluous operations, thereby reducing compute load, memory usage, and inter-process communication overhead.

The present system may support automated detection and handling of exceptional conditions, which further improves system efficiency. Rather than continuously executing all possible automation steps, the present system may monitor intermediate states and trigger additional processing only when specific conditions or anomalies are detected. For example, upon detecting unexpected data values, execution failures, or state inconsistencies, the present system may collect additional diagnostic information, invoke remediation steps, or reroute execution paths. Since the present system limits deeper inspection or processing to cause additional data transactions and processing into certain predefined scenarios, it conserves data processing resources and bandwidth.

The present system may also prevent inefficient or harmful execution paths by suppressing or terminating downstream operations once a fault condition is identified. For example, if an upstream task fails validation or produces an error state, subsequent tasks may be skipped, delayed, or redirected to alternative processing paths. This approach therefore constrains unnecessary data processing by dropping malformed data packets, rate-limiting misbehaving flows, or quarantining compromised nodes, thereby preventing resource exhaustion and preserving overall system stability.

In automated processing pipelines, the present system may route tasks conditionally based on intermediate results, allowing computing resources to be allocated only to operations that require further processing. For example, incoming data items may be evaluated and classified, with only those meeting predefined criteria triggering additional compute-intensive steps, while others are stored or discarded with minimal processing. This selective execution model reduces CPU cycles, memory access, and I/O operations, and improves overall throughput of the system.

The present system is also applicable to large-scale distributed environments where coordination among multiple services or components is required. For example, workflow diagrams may represent interactions among data ingestion services, processing engines, and storage systems, allowing the present system to identify bottlenecks, optimize execution paths, and manage dependencies more efficiently. This approach is analogous to network control systems that coordinate routing, congestion management, and fault recovery across multiple network nodes to maintain efficient data flow.

Through these mechanisms, the present system provides technical improvements to computing efficiency, resource utilization, and system reliability by enabling structured automation, conditional execution, and adaptive control across complex, distributed computing environments.

### Flowcharts

FIG. 5 illustrates an exemplary flow diagram 500 of a method for generating and implementing automation workflows. At step 502, the present system receives, via at least one user interface, user input describing an automation workflow. In some embodiments, the user interface includes a diagramming interface provided by the disclosed diagramming tool. The automation workflow links together users'applications, which may include at least a trigger and one or more subsequent automated actions. Through the user input, a user may enter natural language descriptions via text input fields or voice recognition technology, explaining what the user wants to automate, which applications or services should be integrated, what data needs to be processed, and what outcomes the user expects.

At step 504, the present system analyzes, using one or more artificial intelligence (AI) models, the user input to identify automation requirements, where the automation requirements include at least one of applications to be integrated, data to be processed, actions to be performed, and conditional logic. In some embodiments, natural language processing (NLP) techniques and machine learning algorithms, to parse and analyse the description. The AI identifies key automation requirements by extracting entities such as application names (e.g., Slack, Jira, Gmail), data types (e.g., customer names, email addresses, issue descriptions), actions to be performed (e.g., send notifications, create records, update statuses), and conditional logic (e.g., route high-priority tickets differently from low-priority tickets). The AI models are trained on large datasets of automation workflows, enabling them to understand user intent, recognize patterns corresponding to common automation scenarios, and determine which automation components are required to implement the described process. This analysis phase transforms unstructured natural language into structured automation requirements that can be used to generate functional workflow diagrams.

At step 506, the present system generates, based on the automation requirements, a visual workflow diagram comprising a plurality of automation elements. These elements include nodes representing individual automation steps (such as triggers, actions, and decision points), connectors showing the flow of data and control between steps, and visual representations of automation assets including interfaces for data collection, tables for data storage, chatbots for interactive communication, and automation workflows for processing and integration. The present system may apply layout algorithms to position the nodes and route the connectors in a manner that creates a clear, readable diagram, organizing elements logically from left to right or top to bottom to reflect the sequence of operations. Each automation element is automatically configured with appropriate settings and parameters derived from the user's descriptions, such as form fields for interfaces, column definitions for tables, and trigger-action configurations for workflows. The visual diagram serves as both a planning document and a functional implementation, providing the users with an immediate overview of his/her automation system.

At step 508, the present system implements the automation workflow by configuring and executing the plurality of automation elements within visual workflow diagram. The present system creates functional automation assets/elements in the visual diagram, including fully configured interfaces with validation rules, tables with defined data types and relationships, and automation workflows with specified triggers and actions. These assets are integrated with the underlying automation platform such that they can be immediately activated for production use. In some embodiments, the present system may maintain real-time bidirectional synchronisation between the visual workflow diagram and the corresponding automation configurations, ensuring that changes made to the diagram are reflected in the functional implementation, and vice versa. Once activated, the automation workflow may execute automatically based on defined trigger events, processing data, performing actions, and routing tasks according to the logic specified in the visual diagram. The present system may also monitor execution of the automation workflow to collect performance statistics including run counts, success rates, and time saved, providing a user with insights into the effectiveness and efficiency of the automation processes.

### Computer-Based Implementations

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used and/or functional programming languages can be used. Electrical memory, such as flash-based memory, can be used.

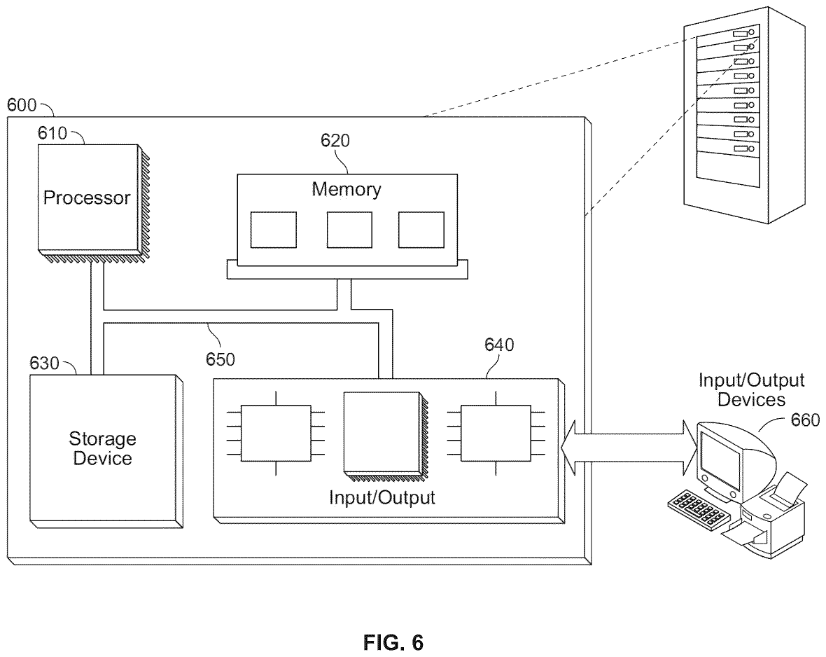

FIG. 6 is a block diagram of an example computer system 600 that may be used in implementing the technology described herein. General-purpose computers, network appliances, mobile devices, or other electronic systems may also include at least portions of the system 600. The system 600 includes a processor 610, a memory 620, a storage device 630, and an input/output device 640. Each of the components 610, 620, 630, and 640 may be interconnected, for example, using a system bus 640. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630.

The memory 620 stores information within the system 600. In some implementations, the memory 620 is a non-transitory computer-readable medium. In some implementations, the memory 620 is a volatile memory unit. In some implementations, the memory 620 is a non-volatile memory unit.

The storage device 630 is capable of providing mass storage for the system 600. In some implementations, the storage device 630 is a non-transitory computer-readable medium. In various different implementations, the storage device 630 may include, for example, a hard disk device, an optical disk device, a solid-state drive, a flash drive, or some other large capacity storage device. For example, the storage device may store long-term data (e.g., database data, file system data, etc.). The input/output device 640 provides input/output operations for the system 600. In some implementations, the input/output device 640 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 660. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 630 may be implemented in a distributed way over a network, such as a server farm or a set of widely distributed servers, or may be implemented in a single computing device.

Although an example processing system has been described in FIG. 6, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-implemented method for generating and implementing automation workflows comprising:
receiving, via at least one user interface, user input describing an automation workflow;
analyzing, using one or more artificial intelligence (AI) models, the user input to identify a plurality of automation requirements, wherein the automation requirements include at least one of applications to be integrated, data to be processed, actions to be performed, and conditional logic;
generating, based on the automation requirements, a visual workflow diagram comprising a plurality of automation elements; and
implementing the automation workflow by configuring and executing the plurality of automation elements within the visual workflow diagram.

2. The method of claim 1, wherein the plurality of automation elements comprises one or more of automation steps, split paths, grouped nodes, interfaces, tables, and connectors.

3. The method of claim 1, further comprising receiving, via the at least one user interface, a user request for modifying an automation element or making a potential optimization at any time in generating and configuring the visual workflow diagram, wherein the automation element is a new automation element or one of the plurality of automation elements.

4. The method of claim 3, further comprising:
analyzing, using the one or more AI models, existing automation elements within the visual workflow diagram in response to receiving the user request; and
generating one or more contextual recommendations based on analyzing the existing automation elements.

5. The method of claim 4, further comprising:
displaying, in the at least one user interface, the one or more contextual recommendations with user interface controls;
receiving, via the user interface controls, an acceptance or a rejection of each of the one or more contextual recommendations from a user; and
in response to receiving an acceptance of a contextual recommendation, automatically modifying the visual workflow diagram to implement the accepted recommendation and providing one or more options for the user to subsequently edit the accepted recommendation.

6. The method of claim 3, wherein the user input or user request is a natural language description in a form of text or voice input.

7. The method of claim 1, further comprising maintaining real-time bidirectional synchronization between the visual workflow diagram displayed in the at least one user interface and corresponding automation configurations.

8. The method of claim 1, further comprising sharing access to the visual workflow diagram with a plurality of users.

9. The method of claim 8, further comprising:
receiving concurrent edits of the workflow diagram from the plurality of users;
merging the concurrent edits to maintain a consistent state of the visual workflow diagram; and
applying one or more conflict resolution algorithms when a conflict arises from the concurrent edits to a same automation element in the visual workflow diagram.

10. The method of claim 1, further comprising enabling a user to add a free-form or element-specific comment.

11. The method of claim 1, further comprising:
receiving, from a user, a selection of a subset of the plurality of automation elements in the visual workflow diagram; and
creating a grouped node of the selected subset of automation elements, wherein the automation elements are moved together when the grouped node is moved, and the automation elements are unaffected when the grouped node is deleted.

12. The method of claim 1, further comprising:
receiving, from a user, a selection of a subset of the plurality of automation elements in the visual workflow diagram and a selection of a layout organization option; and
automatically organizing a layout of the selected subset of automation elements according to the selected layout organization option.

13. The method of claim 1, further comprising monitoring implementation of the automation workflow to collect performance statistics.

14. A computer system for generating and implementing automation workflows comprising:
a processor; and
a memory in communication with the processor and comprising instructions which, when executed by the processor, program the processor to:
receive, via at least one user interface, user input describing an automation workflow;
analyze, using one or more artificial intelligence (AI) models, the user input to identify a plurality of automation requirements, wherein the automation requirements include at least one of applications to be integrated, data to be processed, actions to be performed, and conditional logic;
generate, based on the automation requirements, a visual workflow diagram comprising a plurality of automation elements; and
implement the automation workflow by configuring and executing the plurality of automation elements within the visual workflow diagram.

15. The system of claim 14, wherein the plurality of automation elements comprises one or more of automation steps, split paths, grouped nodes, interfaces, tables, and connectors.

16. The system of claim 14, wherein the instructions further program the processor to receive, via the at least one user interface, a user request for modifying an automation element or making a potential optimization at any time in generating and configuring the visual workflow diagram, wherein the automation element is a new automation element or one of the plurality of automation elements.

17. The system of claim 16, wherein the instructions further program the processor to:
analyze, using the one or more AI models, existing automation elements within the visual workflow diagram in response to receiving the user request; and
generate one or more contextual recommendations based on analyzing the existing automation elements.

18. The system of claim 16, wherein the user input or user request is a natural language description in a form of text or voice input.

19. The system of claim 14, wherein the instructions further program the processor to share access to the visual workflow diagram with a plurality of users.

20. A computer program product for generating and implementing automation workflows, the computer program product comprising a non-transitory computer-readable medium having computer readable program code stored thereon, the computer readable program code configured to:
receive, via at least one user interface, user input describing an automation workflow;
analyze, using one or more artificial intelligence (AI) models, the user input to identify a plurality of automation requirements, wherein the automation requirements include at least one of applications to be integrated, data to be processed, actions to be performed, and conditional logic;
generate, based on the automation requirements, a visual workflow diagram comprising a plurality of automation elements; and
implement the automation workflow by configuring and executing the plurality of automation elements within the visual workflow diagram.
